(19) United States
(12) Patent Application Publication
(10) Pub. No.: US 2010/0278200 A1
(43) Pub. Date: Nov. 4, 2010

(54) EXTERNAL FREQUENCY-QUADRUPED 1064 NM MODE-LOCKED LASER

(75) Inventors: Bernd-Michael Dicks, Damlos (DE); Ruediger Von Elm, Wielen (DE)

Correspondence Address: Coherent, Inc. c/o Morrison & Forester, 425 Market Street, San Francisco, CA, 94105-2482, US

(73) Assignee: Coherent, Inc., Santa Clara, CA (US)

(21) Appl. No.: 12/435,187

(22) Filed: May 4, 2009

(51) Int. Cl. H01S 3/098; H01S 3/10

(52) U.S. Cl. 372/18; 372/22

(57) ABSTRACT

The output of a mode-locked solid-state NIR laser having a pulse duration less than 50 picoseconds at a pulse-repetition frequency is frequency doubled in a nonlinear crystal to provide green radiation. The green radiation is type-I frequency doubled in a BBO crystal to provide UV radiation. The green radiation is focused into an elliptical spot in the BBO crystal with the major axis of the spot in the walk-off plane of the crystal. The length of the crystal is chosen to be much less than the Rayleigh range of the green radiation in the walk-off plane of the BBO crystal.

### TECHNICAL FIELD OF THE INVENTION

The present invention relates in general to harmonic generation of laser output beams. The invention relates in particular to providing UV radiation by frequency quadrupling the output of a mode-locked laser having a fundamental wavelength in the near infrared (NIR) region of the electromagnetic spectrum.

### DISCUSSION OF BACKGROUND ART

Mode-locked lasers having a medium to high output pulse intensity are used extensively in the semiconductor industry for inspection of structured or unstructured wafers. Mode-locked lasers have a very high pulse repetition frequency (PRF), for example about 20 megahertz (MHz) or higher and are often referred to as quasi continuous wave (quasi-CW) lasers.

In an inspection system it is usual to focus the laser beam on the wafer and analyze back-scattered radiation from the wafer. Typically the wafer is rotated in a tool and the laser beam is scanned radially over the rotating wafer. Depending on the results of the analysis it can be decided if a wafer is suitable for further processing, must be further cleaned, or disposed of. Inspection systems are used by both manufacturers of wafers and manufacturers of semiconductor chips.

Requirements of a wafer inspection system include a high spatial resolution, a high wafer throughput per unit time, and sufficient reliability to operate for 24 hours per day, seven days per week. Manual intervention in a system and components of the system should to the maximum extent possible occur only at predetermined times set for regular maintenance of the system. As the system is typically used in a clean-room environment it is essential that the system be very cleanly prepared.

Quasi-CW operation is preferred to enable essentially continuous scanning. The shortest possible wavelength radiation, i.e., ultraviolet (UV) radiation, is required to provide the highest resolution. Laser output should have as low noise and as high stability as possible. This should all be achievable with maintenance free operation over periods between scheduled maintenance of as long as one month, with a lifetime as long as 10,000 hours.

The relatively high intensity of mode-locked laser pulses makes external harmonic generation in optically nonlinear crystals relatively efficient without a need to operate the crystals in a passive resonator, which is sensitive to environmental disturbances and requires active control to maintain a resonant condition. Laser radiation for harmonic conversion can be supplied by a passively modelocked solid-state laser or fiber-laser having a wavelength in the NIR spectral region between about 1020 nanometers (nm) to 1090 nm. Neodymium-doped solid-state lasers typically deliver fundamental radiation at about 1064 nm wavelength. This can be converted to UV radiation at a wavelength of about 266 nm by frequency quadrupling (fourth harmonic or 4H generation) in two optically nonlinear crystals. 1064 nm radiation is converted into 532 nm radiation in a first optically nonlinear crystal. The 532 nm radiation is converted to 266 nm radiation in a second optically nonlinear crystal.

Degradation of the second crystal, particularly the output face of the crystal and bulk material toward the output face, by the UV radiation is essentially unavoidable. This can be mitigated, however, by periodically moving (shifting) the crystal such that the UV radiation is sequentially incident on different spots on the surface. The individual spot lifetimes can be as long as 1,000 hours while maintaining the effects of the degradation within the stability criteria of an inspection system. Shifting is typically effected automatically. NIR solid-state and fiber lasers typically have stable, low-noise output over at least the 10,000 hours required.

A presently most preferred method for external 4H-generation (4HG) from the output of mode-locked lasers is the use of a cesium lithium borate (CLBO) crystal with type-I phase-matching (phase-matching with walk off). CLBO exhibits a relatively small walk-off angle, adequately high nonlinearity, and a high acceptance angle. A disadvantage of CLBO is that it is very hygroscopic. This causes difficulty in handling and storing the crystals and is disadvantageous for industrial processes. Further, there are indications that trapped moisture in CLBO together with the UV radiation can lead to formation of scattering centers along the UV beam path.

Another optically nonlinear crystal material that has been used for external 4H-generation with type-I phase matching is beta barium borate (BBO). This has been used for extensively in the past for frequency-doubling in Q-switched lasers. BBO possesses a higher nonlinearity than that of CLBO, however, the walk-off is much greater and the acceptance angle is smaller than those of CLBO. The greater walk-off and small acceptance angle lead to a poorer beam quality (M²) in the phase-matching plane (walk-off plane), which is a reason why CLBO is presently preferred. BBO, however, is much less hygroscopic than CLBO, and can be manufactured in high volume with very good optical quality. There is a need for a 4H-generation arrangement, using type-I phase matching, in BBO that could mitigate, if not entirely compensate for, the disadvantages of the material in high walk-off angle and small acceptance angle. This together with the conversion efficiency and reliability advantages provided by mode-locked lasers would be very advantageous to makers and users of optical inspection systems for the semiconductor industry.

### SUMMARY OF THE INVENTION

In one aspect, apparatus in accordance with the present invention comprises a mode-locked laser arranged to deliver repeated pulses of near infrared (NIR) radiation having a duration about equal to or less than 50 picoseconds at a pulse-repetition frequency (PRF) about equal to or greater than 20 megahertz. A first optically nonlinear crystal is arranged for non-resonant frequency-doubling of the NIR radiation to provide corresponding pulses of green radiation. A second optically nonlinear crystal of beta barium borate (BBO) having a predetermined length and arranged for non-resonant type-I frequency-doubling of the green radiation is provided for providing corresponding pulses of ultraviolet (UV) radiation. The BBO crystal is characterized as having a walk-off plane and a non walk-off plane perpendicular to the walk-off plane. An optical arrangement is provided for focusing the green radiation into the BBO crystal for the frequency doubling such that the focused green-radiation beam has an elliptical cross-section in the BBO crystal, with a major axis in the walk-off plane and a minor axis in the non walk-off plane. The focused green radiation has a Rayleigh range in the walk-off plane greater than about 10 times the length of the BBO crystal.

In the detailed description of the present invention set forth below, it is demonstrated theoretically that the combination of short pulse duration and high pulse repetition rate and high pulse repetition frequency provide for significantly lower UV degradation of fourth-harmonic conversion crystals. The present invention provides that a BBO crystal can be used to replace an environmentally sensitive and damage prone CLBO crystal for fourth harmonic conversion without sacrifice of UV output beam quality.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A and FIG. 1B are graphs schematically illustrating UV radiation beam quality delivered from a BBO crystal in the non walk-off and walk-off planes respectively of the crystal in response to frequency doubling of a focused green radiation beam having a Rayleigh range in the walk-off plane greater than 10 times the length of the crystal in accordance with principles of the present invention.

FIG. 2A and FIG. 2B are views in two transverse axes perpendicular to each other schematically illustrating a preferred embodiment of laser apparatus in accordance with the present invention including a BBO crystal arranged for type-I frequency doubling of green radiation with the green radiation focused to an elliptical spot in the BBO crystal.

FIG. 2C is a view seen generally in the direction 2C-2C of FIG. 2B schematically illustrating generalized dimensions of the focal spot in the BBO crystal of the apparatus of FIGS. 2A and 2B.

### DETAILED DESCRIPTION OF THE INVENTION

Before discussing principles the inventive fourth-harmonic conversion in BBO, it is useful to consider what influence the choice of laser system for providing fundamental radiation has on the lifetime of any crystal used for the fourth-harmonic generation (4HG). Three systems are compared in a following analysis. These are: a CW laser system with fourth-harmonic generation in an external resonator; a short-pulse laser such as a mode-locked solid state laser having a pulse duration less than about 50 picoseconds; and a long-pulse laser such as a fiber-laser having a pulse duration greater than 50 picoseconds.

It is assumed that the UV degradation rate of a 4HG crystal is proportional to the average UV intensity in the crystal. This is based on a concept of an effective cross-section (effective surface) for the UV damage.

The cause of the generation of 4H-radiation is the peak intensity of the 2H-radiation (green-radiation). This depends from the choice of the source of fundamental radiation and the choice of focusing in the crystal. The relationship between the average UV power and the average UV intensity in the 4HG crystal is given by the following equation:

P̅_{UV}=π·w_{0,UV}²·Ī_{UV} (1)

The average green power can be calculated from the peak green intensity in the crystal as follows:

P̅_{green}=fᵣₑₚ·τ_{green}·π·w_{0,green}²·Î_{green} (2)

where w₀ is the beam radius in the crystal (green or UV), τ is the pulse length (pulse duration), and fᵣₑₚ is the pulse repetition rate of the pulsed laser.

Dividing equations (1) and (2) and solving for the average UV intensity leads to a dependence of the average UV intensity, and accordingly the UV degradation rate, on the peak green intensity as follows:

$${\overline{I}}_{UV} = \sqrt{2} \cdot {f}_{rep} \cdot {τ}_{IR} \frac{{\overline{P}}_{UV}}{{\overline{P}}_{green}} \cdot {\hat{I}}_{green} = η \cdot {\hat{I}}_{green} \qquad ( 3 )$$

For simplicity it is assumed that the green and UV beam-waists, and also the IR pulse-duration and the green pulse-duration, have a √2 relationship (with no walk-off effect and no depletion effect considered). The term η can be thought of as a “quality factor” which describes how 4H-generation systems using the same peak green intensity behave relative to each other regarding UV degradation. Otherwise expressed, the UV degradation is proportional to the peak green intensity. For a resonant doubling of CW radiation: in equation (2) the product fᵣₑₚ·τ_{green} must be replaced by the green transmission T_{green}; and in equation (3) the factor √2 must be replaced by 2.

TABLE 1 gives an overview of the quality factors for the three laser systems being compared. A resonant enhancement of 80 times is assumed for the CW case with resonator losses for the green radiation estimated at 1.2%. It can be seen that the short-pulse laser has clearly the best quality factor, which means that the lowest degradation rate is to be expected for the 4HG crystal, all else being equal. If the three systems are compared according to the same conversion efficiency, the degradation rates for the three systems (short pulse: long pulse: CW) have UV degradation rates in a ratio 1:5:12. This theoretically demonstrates a clear superiority of mode-locked solid-state lasers relative to UV degradation of fourth-harmonic conversion crystals.

TABLE 1

| Laser | | | | | | |
|---|---|---|---|---|---|---|
| System | P̅_{green} | P̅_{UV} | fᵣₑₚ | τ_{IR} | P̅_{UV}/ P̅_{green} | η |
| Long | 60 W | 3 W | 120 MHz | 75 ps | 5% | 6.3 · 10⁻⁴ |
| Pulse | | | | | | |
| Short | 12.5 W | 0.5 W | 120 MHz | 15 ps | 4% | 1.0 · 10⁻⁴ |
| Pulse | | | | | | |

| | | | | | |
|---|---|---|---|---|---|
| CW | 8 W | 0.2 W | T_{green} = 1.2% | 2.5% | 6.0 · ¹⁰⁻⁴ |

In nonlinear frequency doubling (conversion) using type-I phase-matching (critical phase-matching) in an optically nonlinear crystal, the frequency conversion is accompanied by a so called walk-off of the frequency-converted radiation. This means, in the case of fourth-harmonic conversion, that the UV radiation beam generated in the crystal relative to the green radiation beam by an angle ρ, the so called walk-off angle. This walk-off effect in the case of a radially symmetric focusing of the green beam in the crystal causes the UV beam at the exit surface of the crystal to appear elliptical, with the major axis being due to the walk-off effect. The ratio of the UV beam transverse axes at the exit surface of the crystal can be approximated by an equation:

$$\frac{{w}_{e}}{{w}_{0}} = {\sqrt{1 + ( \frac{L \cdot ρ}{2 {w}_{0}} )}}^{2} \qquad ( 4 )$$

Where L is the length of the crystal is the walk-off angle and wₑ is the UV beam radius (width) in the walk off plane w₀ is the UV beam width in the non walk-off plane (perpendicular to the walk-off plane). Width w₀ for the UV is approximately w₀ for the green divided by √2.

The UV beam expansion in the walk-off plane leads to a degradation of the beam quality M², which can be approximated by an equation:

$${M}^{2} = {\sqrt{1 + \frac{1}{2 {π}^{2}} ( \frac{L \cdot ρ}{2 {w}_{0}} )}}^{2} \qquad ( 5 )$$

While the ellipticity of the beam can be corrected with suitable optics, the reduction in beam quality is not correctable without further measures. For “ideal” optics the M² remains constant over the beam expansion. However, for real optics, i.e., optics with finite aberrations, M² becomes bigger over the beam expansion. M² can be reduced, with a power-reduction penalty, by beam diffraction in conjunction with an aperture. This, however, requires time-consuming adjustment and is not acceptable.

In the case of BBO, the walk-off angle is 85 milliradians (mrad) which is relatively large compared with that of CLBO, which has a walk-off angle of 30 mrad. This has led to a wide-spread, false perception that an acceptable beam quality can not be achieved with fourth-harmonic generation in BBO. The falsity of the perception can be explained as follows.

In order to guarantee a predetermined beam quality in the walk-off plane, the focusing (of the beam to be converted) must satisfy the following conditions:

2w₀>k·L·ρ (6)

To guarantee an M²<1.2 the factor k is 0.34. To guarantee an M²<1.1 the factor k is 0.49. Accordingly it is possible, through a corresponding weak focusing of the green beam in the walk-off plane to achieve an acceptable beam quality even in a 4HG crystal with strong walk-off, such as a BBO crystal

The 4HG process has only a limited acceptance angle for an input beam. Exceeding this angle leads to a reduction of the 4H power and a corresponding distortion of the 4H beam profile. In BBO the acceptance angle at full-width half maximum (FWHM) is related to the 4H power by an equation:

Δθ·L=0.19 mrad·cm (7)

This value is relatively small compared with that for CLBO, which is 0.54 mrad·cm, so that in focusing the green beam in the walk-off plane the condition of equation (7) must be taken into account.

A green beam having a Gaussian transverse intensity distribution is characterized by a Rayleigh length (Rayleigh range) z_{R}, which is given by an equation:

$${z}_{R} = π \cdot \frac{{w}_{0 , green}^{2}}{λ} \qquad ( 8 )$$

The local divergence angle θ(z) of the green beam with a beam waist in position z₀ can be calculated as follows:

$$θ ( z ) = \frac{{w}_{0 , green}}{{z}_{R}} \cdot \frac{1}{\sqrt{1 + {( \frac{{z}_{R}}{z - {z}_{0}} )}^{2}}} \qquad ( 9 )$$

where the first factor describes the far field divergence of the green beam and the second factor describes the suppression of the far field divergence near the waist position z₀.

By way of example, for a green beam having a diameter of 0.3 millimeters (mm) in the center of a 5 mm-long BBO crystal, z_{R} would be 130 mm and θ (exit surface) would be 1.1 mrad·cm. In this case the local divergence at the exit surface of the crystal is only 2% of the far-field divergence. The resulting full-angle of 0.04 mrad is well under the 0.38 mrad acceptance angle of the BBO crystal. This indicates that by a weak focusing of the green beam in the walk-off plane (green Rayleigh range much greater than the length of the 4HG crystal) the 4H generation process can be maintained within the acceptance angle of the crystal. With a weakly diverging green beam, the beam waist does not even need to lie within the crystal. Further, as discussed above, the weak focusing in the walk-off plane can provide that beam quality is maintained in both the walk-off and non walk-off planes.

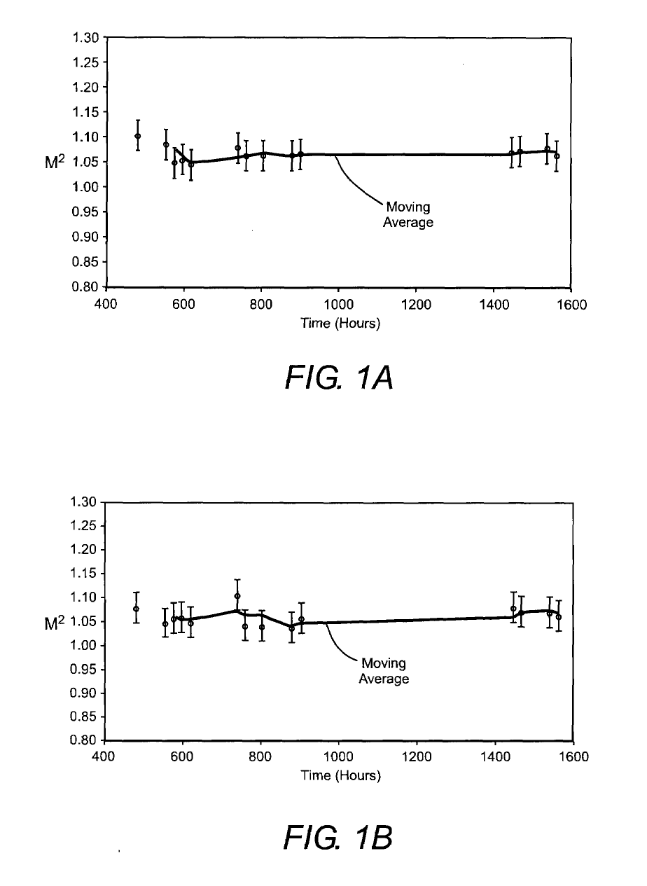

FIG. 1A and FIG. 1B are graphs schematically illustrating measured beam quality values (and the moving average thereof), in respectively the non walk-off plane and the walk-off plane, as a function of operation hours, up to 1600 hours, for a UV beam from an externally frequency-quadrupled mode-locked neodymium-doped yttrium vanadate (Nd:YVO₄) laser using a BBO crystal for fourth-harmonic generation. In this example, the green beam had a radially symmetrical (about circular) focal spot of about 0.3 mm (300 μm) in diameter in the BBO. The Rayleigh range of the beam, in the walk-off plane is 130 mm, as discussed above. The BBO crystal has a length of 5.0 mm. It can be seen that over the measurement period there is no recognizable beam quality difference in the two planes. In each plane, M² remains under 1.1.

It should be noted, here that in the experiment of FIGS. 1A and 1B a circular focal spot was used for convenience. Clearly, this would not provide the maximum possible conversion efficiency of the green radiation to UV radiation. In a practical arrangement intensity could be increased by increasing the strength of focus in the non walk-off plane (only) using an appropriate optical arrangement. This would provide that the focal spot in the BBO is elliptical with a major axis 2·w_{WO,green} in the walk-off plane and 2·w_{NWO,green} in the non walk-off plane.

In order to maintain conversion efficiency as beam focus in the walk-off plane is weakened the beam area (A) must be maintained constant as defined by an equation:

A=π·w_{0,green}²=π·w_{WO,green}·w_{NWO,green} (10)

Where w_{0,green} is the focal-spot radius of an “equivalent” radially symmetrical focal spot providing a target conversion efficiency, and 2·w_{WO,green} and 2·w_{NWO,green} are the beam widths at focus in the walk-off and non walk-off planes, respectively.

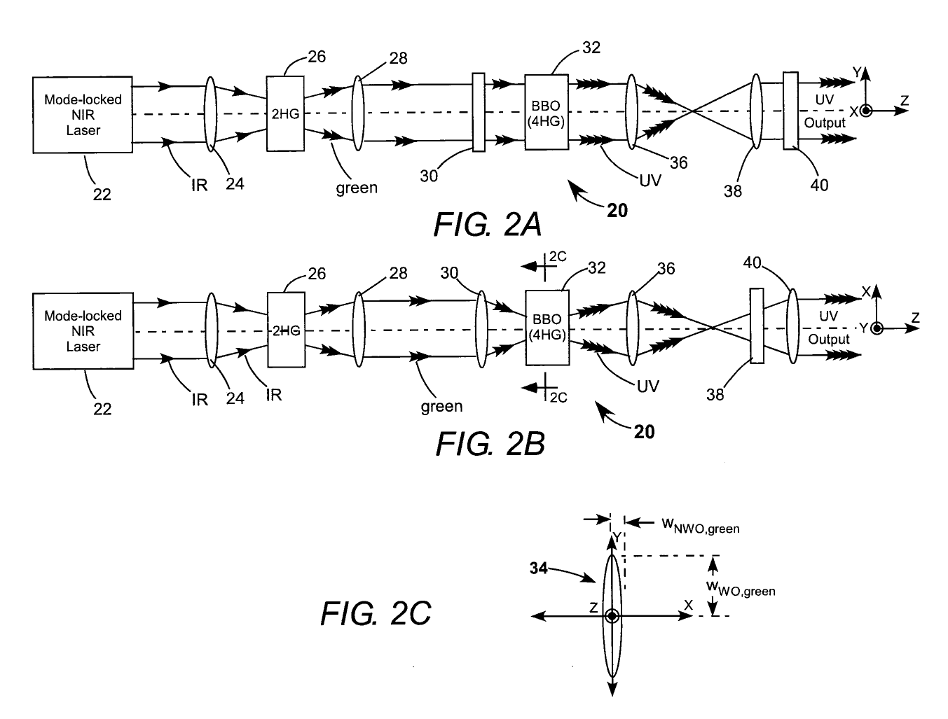

FIG. 2A and FIG. 2B schematically illustrate one preferred embodiment 20 of a externally non-resonant frequency-quadrupled mode-locked laser apparatus in accordance with the present invention and in which fourth-harmonic generation is accomplished by non-resonant frequency-doubling with elliptical focus in a BBO crystal arranged for type-I phase matching. FIG. 2A depicts the apparatus in the walk-off plane (here the Y-Z) plane of crystal 32. FIG. 2B depicts the apparatus in the non walk-off plane (here the X-Z) plane of crystal 32.

Apparatus 20 includes a mode-locked laser 22 delivering pulsed IR radiation having a wavelength of about 1064 nm, a pulse duration less than about 50 picoseconds at a frequency greater than about 20 MHz. The IR radiation (indicated by a single arrowhead) is focused by a spherical lens 24 into a 2H-generating (2HG) crystal 26. Crystal 26 is preferably a crystal of lithium triborate (LBO) but this should not be considered limiting. Green radiation (indicated by double arrowheads) generated in crystal 26 is collimated by a spherical lens 28. The collimated green-radiation beam is then focused into BBO crystal 32 by a cylindrical lens 30 having optical power only in the non walk-off plane. This produces an elliptical focal-spot 34 (see FIG. 2C) in crystal 32 having a major axis 2·w_{WO,green} in the walk-off plane and 2·w_{NWO,green} in the non walk-off plane as discussed above. A UV (designated by quadruple arrowheads) output beam is generated by crystal 32. The output beam will have about the same ellipticity as focal spot 34. The elliptical UV beam is converted to a circular UV output beam by a spherical lens 36, a cylindrical lens 38 having optical power only in the walk-off (Y-Z) plane, and a cylindrical lens 40 having optical power only in the non walk-off (X-Z) plane.

Preferably, laser 22 delivers pulses having a duration of about 50 picoseconds or less at a pulse-repetition frequency fᵣₑₚ greater than about 20 MHz. One preferred combination of duration and frequency is 15 picoseconds and 120 MHz. The UV conversion efficiency in BBO crystal 32, i.e., the average UV power generated as a percentage of the average green power input, should be greater than 1%. The Rayleigh range of the green radiation in the BBO crystal should be equal to or greater than ten times the length of the crystal. The beam quality M² of the UV radiation will be less than 1.2 in both the walk-off and non walk-off planes.

It should be noted here that optical arrangements for separating unconverted IR and green radiation for the UV output are not shown in FIGS. 2A and 2B for simplicity of illustration. Such arrangements are well known in the art and a description thereof is not necessary for understanding principles of the present invention. While apparatus 20 provides for only single pass non-resonant frequency conversion in optically nonlinear crystals 26 and 32, those skilled in the art will also recognize that apparatus such could be configured for double-pass conversion, albeit at the expense of cost and complexity. Those skilled in the art will further recognize that the optical arrangement of FIGS. 2A and 2B is not the only arrangement possible for generating focal spot 34 in crystal 32 and re-shaping the output UV beam, and may employ other arrangements without departing from the spirit and scope of the present invention.

In summary, the present invention is described above in terms of a preferred and other embodiments. The invention is not limited, however, to the embodiments described and depicted. Rather, the invention is limited only by the claims appended hereto.

What is claimed is:

1. Optical apparatus, comprising:
a mode-locked laser arranged to deliver repeated pulses of near infrared (NIR) radiation having a duration about equal to or less than 50 picoseconds at a pulse-repetition frequency (PRF) about equal to or greater than 20 megahertz;
a first optically nonlinear crystal arranged for non-resonant frequency-doubling of the NIR radiation to provide corresponding pulses of green radiation;
a second optically nonlinear crystal of beta barium borate (BBO) having a predetermined length and arranged for non-resonant type-I frequency-doubling of the green radiation to provide corresponding pulses of ultraviolet (UV) radiation, the BBO crystal being characterized as having a walk-off plane and a non walk-off plane perpendicular to the walk-off plane; and
wherein an optical arrangement is provided for focusing the green radiation into the BBO crystal for the frequency doubling such that the focused beam has an elliptical cross-section in the BBO crystal with a major axis in the walk-off plane and a minor axis in the non walk-off plane, and the focused green radiation has a Rayleigh range in the walk-off plane greater than about 10 times the length of the BBO crystal.

2. The apparatus of claim 1, wherein the NIR radiation has a wavelength of about 1064 nm.

3. The apparatus of claim 1, wherein an optical arrangement is provided for focusing the green radiation in BBO crystal is arranged such that the green radiation is about collimated in the walk-off plane of the BBO crystal.

4. The apparatus of claim 1, wherein the pulse duration of the IR radiation is about 15 picoseconds and the PRF is about 120 MHz.

5. The apparatus of claim 1, wherein the average power of UV radiation is greater than 1% of the average power of green radiation.

6. The apparatus of claim 1, wherein the UV radiation has a beam-quality M² less than about 1.2 measured in each of the walk-of and non-walk off planes.

7. Optical apparatus, comprising:
a mode-locked laser arranged to deliver repeated pulses of near infrared (NIR) radiation having a duration about equal to or less than 50 picoseconds at a pulse-repetition frequency (PRF) about equal to or greater than 20 megahertz;
a first optically nonlinear crystal arranged for non-resonant frequency-doubling of the NIR radiation to provide corresponding pulses of green radiation;
a second optically nonlinear crystal of beat barium borate (BBO) having a predetermined length and arranged for non-resonant type-I frequency-doubling of the green radiation to provide corresponding pulses of ultraviolet (UV) radiation, the BBO crystal being characterized as having a walk-off plane and a non walk-off plane perpendicular to the walk-off plane;
wherein an optical arrangement is provided for focusing the green radiation into the BBO crystal for the frequency doubling such that the focused beam has an elliptical cross-section in the BBO crystal with a major axis in the walk-off plane and a minor axis in the non walk-off plane, and the focused green radiation has a Rayleigh range in the walk-off plane greater than about 10 times the length of the BBO crystal; and
wherein the average power of UV radiation is greater than 1% of the average power of green radiation, and the UV radiation has a beam-quality, M², less than about 1.2 measured in each of the walk-of and non-walk off planes.

8. The apparatus of claim 7, wherein the NIR radiation has a wavelength of about 1064 nm.

9. The apparatus of claim 7, wherein an optical arrangement is provided for focusing the green radiation in BBO crystal is arranged such that the green radiation is about collimated in the walk-off plane of the BBO crystal.

10. The apparatus of claim 7, wherein the pulse duration of the IR radiation is about 15 picoseconds and the PRF is about 120 MHz.
